(19) United States
(12) Patent Application Publication
(10) Pub. No.: US 2010/0052434 A1
(43) Pub. Date: Mar. 4, 2010

(54) SWITCHGEAR CELL FOR SWITCHING FIVE OR MORE VOLTAGE LEVELS

(75) Inventor: Christoph Haederli, Zurich (CH)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zurich (CH)

(21) Appl. No.: 12/552,747

(22) Filed: Sep. 2, 2009

(30) Foreign Application Priority Data
Sep. 4, 2008 (EP) 08163678.9

(51) Int. Cl. H02J 4/00

(52) U.S. Cl. 307/113

(57) ABSTRACT

A switchgear cell is disclosed for switching n switching voltage levels, where n is an odd number of 5 or greater (i.e., n=5, 7, 9, . . . ,) is specified. The switchgear cell includes a first and a second branch circuit, wherein each branch circuit includes n-1 series-connected power semiconductor switches and p=n-2 power semiconductor switch junction points among the series-connected power semiconductor switches of each branch circuit. An intermediate circuit includes a first and a second capacitance, the first capacitance being connected to a power semiconductor switch junction point having an odd counting number x of the first branch circuit when the power semiconductor switch junction points can be counted starting with an odd counting number x from the first end to the second end of a respective branch circuit. The second capacitance is connected to a power semiconductor switch junction point of the second branch circuit. A power semiconductor switch of the intermediate circuit is connected to a power semiconductor switch junction point having a counting number x<(p+1)/2 of the first or second branch circuit or to the first end. Alternatively, the intermediate circuit includes a capacitance connected to a power semiconductor switch junction point having a counting number x<(p+1)/2 of the first and second branch circuits, and a power semiconductor switch connected to a power semiconductor switch junction point having a counting number x<(p+1)/2 of the first or second branch circuit. Another power semiconductor switch of the intermediate circuit is connected to a power semiconductor switch junction point having a counting number x≦(p+1)/2 of the first or second branch circuit, and is not directly connected to the capacitance of the intermediate circuit.

### RELATED APPLICATION

This application claims priority under 35 U.S.C. §119 to European Patent Application No. 08163678.9 filed in Europe on Sep. 4, 2008, the entire content of which is hereby incorporated by reference in its entirety.

### FIELD

The disclosure relates to power electronic circuits, such as a switchgear cell for switching five or more voltage levels.

### BACKGROUND INFORMATION

Power semiconductor switches are currently being increasingly used in converter technology, such as in converter circuits for switching a multiplicity of voltage levels. A switchgear cell of such a converter circuit is specified in FIG. 2 of WO 2007/087732 A1. The switchgear cell includes a first and a second branch circuit, wherein each branch circuit has two series-connected controllable bidirectional power semiconductor switches with a controlled unidirectional current-carrying direction (reverse conducting switch). First ends of the two branch circuits are connected to one another, wherein the connection forms an AC voltage phase connection. In addition, second ends of the two branch circuits are connected to one another via a series circuit of two energy stores. Furthermore, the switchgear cell includes an intermediate circuit having a power semiconductor switch arrangement and a capacitance, wherein the power semiconductor switch arrangement is connected to the junction point between the two energy stores connected in series. The capacitance of the intermediate circuit and the power semiconductor switch arrangement are furthermore connected to the junction points between the controllable bidirectional power semiconductor switches of the two branch circuits.

The abovementioned switchgear cell in WO 2007/087732 A1 makes it possible to switch five switching voltage levels. In addition, the connections of the switchgear cell and thus the construction thereof can be complicated, with the result that a realization of the switchgear cell according to WO 2007/087732 A1 involves a high outlay.

### SUMMARY

A switchgear cell for switching n or less switching voltage levels is disclosed, where n is an odd number of 5 or greater, the switchgear cell comprising: a first and a second branch circuit, wherein each branch circuit includes n-1 series-connected controllable bidirectional power semiconductor switches which are reverse conducting, first ends of the branch circuits being connected to one another, and second ends of the branch circuits being connected to one another via a series circuit of a first and a second energy store; p=n-2 power semiconductor switch junction points among the series-connected controllable bidirectional power semiconductor switches having a controlled unidirectional current-carrying direction within each branch circuit; and an intermediate circuit connected to a junction point between the first and the second energy store, the intermediate circuit including: multiple power semiconductor switches; and a first and a second capacitance wherein the first capacitance is connected to a power semiconductor switch junction point having an odd counting number x of the first branch circuit when the power semiconductor switch junction points of each branch circuit are numbered starting with an odd counting number x from the first end to the second end of each respective branch circuit, and wherein the second capacitance is connected to a power semiconductor switch junction point of the second branch circuit, a power semiconductor switch of the intermediate circuit being directly connected to a power semiconductor switch junction point having a counting number x<(p+1)/2 of the first or second branch circuit or being directly connected to the first end of the first or the second branch circuit.

A switchgear cell for switching n or less switching voltage levels is disclosed, where n is an odd number of 5 or greater, the switchgear cell comprising: a first and a second branch circuit, wherein each branch circuit includes n-1 series-connected controllable bidirectional power semiconductor switches having a controlled unidirectional current-carrying direction, first ends of the branch circuits being connected to one another, and second ends of the branch circuits being connected to one another via a series circuit of a first and a second energy store; p=n-2 power semiconductor switch junction points among the series-connected controllable bidirectional power semiconductor switches having a controlled unidirectional current-carrying direction within each branch; and an intermediate circuit connected to a junction point between the first and the second energy store, the intermediate circuit including: multiple power semiconductor switches; and a capacitance, wherein the capacitance is connected to a power semiconductor switch junction point having a counting number x<(p+1)/2 of the first and second branch circuits when the power semiconductor switch junction points are counted starting with an odd counting number x from the first end to the second end of each respective branch circuit, a power semiconductor switch of the intermediate circuit being connected to a power semiconductor switch junction point having a counting number x<(p+1)/2 of the first or second branch circuit, and wherein another of the power semiconductor switches of the intermediate circuit is directly connected to a power semiconductor switch junction point having a counting number x≦(p+1)/2 of the first or second branch circuit, and the another power semiconductor switch of the intermediate circuit is not directly connected to the capacitance of the intermediate circuit.

A switchgear cell for switching n or less switching voltage levels is disclosed, where n is an odd number of 5 or greater, the switchgear cell comprising: a first and a second branch circuit, wherein each branch circuit includes n-1 series-connected controllable bidirectional power semiconductor switches having a controlled unidirectional current-carrying direction, first ends of the branch circuits being connected to one another, and second ends of the branch circuits being connected to one another via a series circuit of a first and a second energy store; p=n-2 power semiconductor switch junction points among the series-connected controllable bidirectional power semiconductor switches having a controlled unidirectional current-carrying direction within each branch circuit; and an intermediate circuit connected to a junction point between the first and the second energy store, the intermediate circuit including: multiple power semiconductor switches; and a first and a second capacitance, wherein the first capacitance is connected to a power semiconductor switch junction point having an odd counting number x of the first branch circuit when the power semiconductor switch junction points are counted starting with an odd counting number x from the first end to the second end of each respective branch circuit, and the second capacitance is connected to a power semiconductor switch junction point of the second branch circuit, a power semiconductor switch of the intermediate circuit being connected only to a power semiconductor switch junction point having a counting number x=(p+1)/2 of the first branch circuit or only to a power semiconductor switch junction point having a counting number x=(p+1)/2 of the second branch circuit.

### BRIEF DESCRIPTION OF THE DRAWINGS

Various objects, advantages and features of the present disclosure will become apparent from the following detailed description of exemplary embodiments of the disclosure in conjunction with the drawings.

In the figures:

FIG. 1 shows a first exemplary embodiment of a switchgear cell according to the disclosure;

FIG. 2 shows a second exemplary embodiment of a switchgear cell according to the disclosure;

FIG. 3 shows a third exemplary embodiment of the switchgear cell according to the disclosure;

FIG. 4 shows a fourth exemplary embodiment of the switchgear cell according to the disclosure;

FIG. 5 shows a fifth exemplary embodiment of the switchgear cell according to the disclosure;

FIG. 6 shows a sixth exemplary embodiment of the switchgear cell according to the disclosure;

FIG. 7 shows a seventh exemplary embodiment of the switchgear cell according to the disclosure;

FIG. 8 shows an eighth exemplary embodiment of the switchgear cell according to the disclosure;

FIG. 9 shows a ninth exemplary embodiment of the switchgear cell according to the disclosure; and

FIG. 10 shows a tenth exemplary embodiment of the switchgear cell according to the disclosure.

The reference symbols used in the drawings and their meanings are summarized in the List of reference symbols. In principle, identical parts are provided with identical reference symbols in the figures. The embodiments described represent the subject matter of the disclosure by way of example and are not intended to be restrictive.

### DETAILED DESCRIPTION

An exemplary switchgear cell is disclosed herein by which five or more voltage levels can be switched, and which can be realized in a simple manner.

A switchgear cell according to the disclosure for switching n switching voltage levels, where n is an odd number of 5 or greater (i.e., n=5, 7, 9, . . . ,) can include a first and a second branch circuit, wherein each branch circuit comprises n-1 series-connected controllable bidirectional power semiconductor switches having a controlled monodirectional current direction (controllable bidirectional reverse conducting power semiconductor switches). First ends of the branch circuits can be connected to one another and second ends of the branch circuits can be connected to one another via a series circuit of a first and a second energy store.

Furthermore, p=n-2 power semiconductor switch junction points exist between the series-connected controllable bidirectional power semiconductor switches having a controlled monodirectional current direction (reverse conducting) of each branch circuit, wherein for each branch circuit the power semiconductor switch junction points can be counted starting with an odd counting number x from the first end to the second end of the respective branch circuit.

Furthermore, an intermediate circuit can be provided, which is connected to the junction point between the first and the second energy store and which can comprise a multiplicity of power semiconductor switches. According to the disclosure, an exemplary intermediate circuit includes a first and a second capacitance, wherein the first capacitance is connected to a power semiconductor switch junction point having an odd counting number x of the first branch circuit (when x is defined as disclosed herein), and the second capacitance is connected to a power semiconductor switch junction point of the second branch circuit. In addition, a power semiconductor switch of the intermediate circuit can be directly connected to a power semiconductor switch junction point having a counting number x<(p+1)/2 of the first or second branch circuit or to the first end.

As an alternative thereto, the power semiconductor switch of the intermediate circuit, according to the disclosure, can be connected only to a power semiconductor switch junction point having a counting number x=(p+1)/2 of the first branch circuit or only to a power semiconductor switch junction point having a counting number x=(p+1)/2 of the second branch circuit.

In a further alternative according to the disclosure, the intermediate circuit can include a capacitance, wherein the capacitance is connected to a power semiconductor switch junction point having a counting number x<(p+1)/2 of the first and second branch circuits. Furthermore, as an alternative, a power semiconductor switch of the intermediate circuit can be connected to a power semiconductor switch junction point having a counting number x<(p+1)/2 of the first or second branch circuit, and another power semiconductor switch of the intermediate circuit can be directly connected to a power semiconductor switch junction point having a counting number x≦(p+1)/2 of the first or second branch circuit, wherein the further power semiconductor switch of the intermediate circuit is then not directly directed to the capacitance of the intermediate circuit. What can thereby be realized is a switchgear cell for switching n switching voltage levels, where n=5, 7, 9, . . . , having particularly few components and connections in respect thereof. A particularly simple switchgear cell can be provided which in addition to using a small space can constitute an alternative solution to known systems. As a result of low circuitry outlay, an exemplary switchgear cell according to the disclosure can be very robust, not very susceptible to interference and can be distinguished by a high availability. On account of the low circuitry outlay, the control outlay with regard to the switching elements can in addition likewise be kept low. An exemplary advantage of a switchgear cell disclosed herein is that it is possible to set or regulate the current at the junction point between the first and the second energy store by the intermediate circuit in a bidirectional direction. The abovementioned alternative switchgear cell according to the disclosure additionally can manage with just one capacitance.

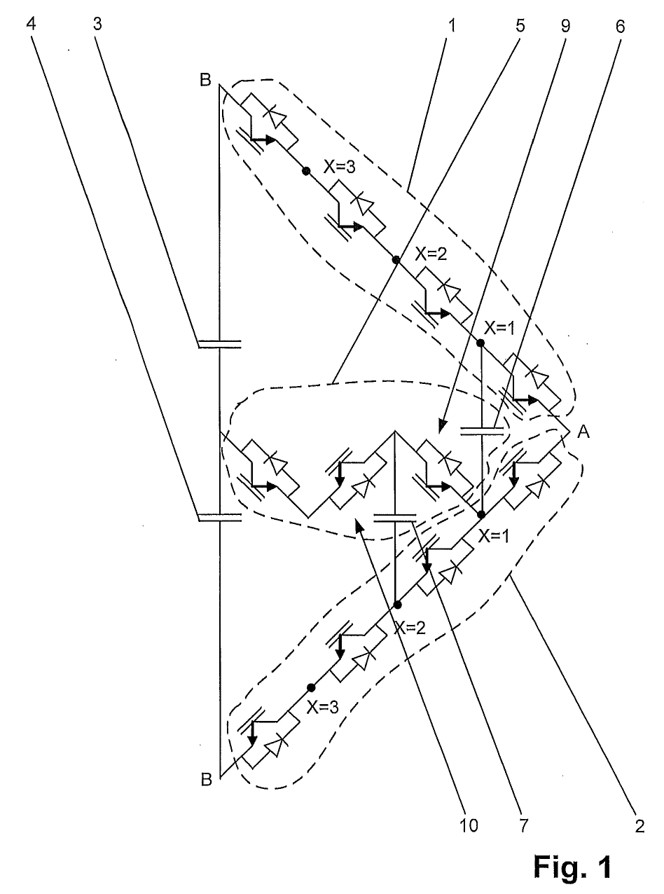

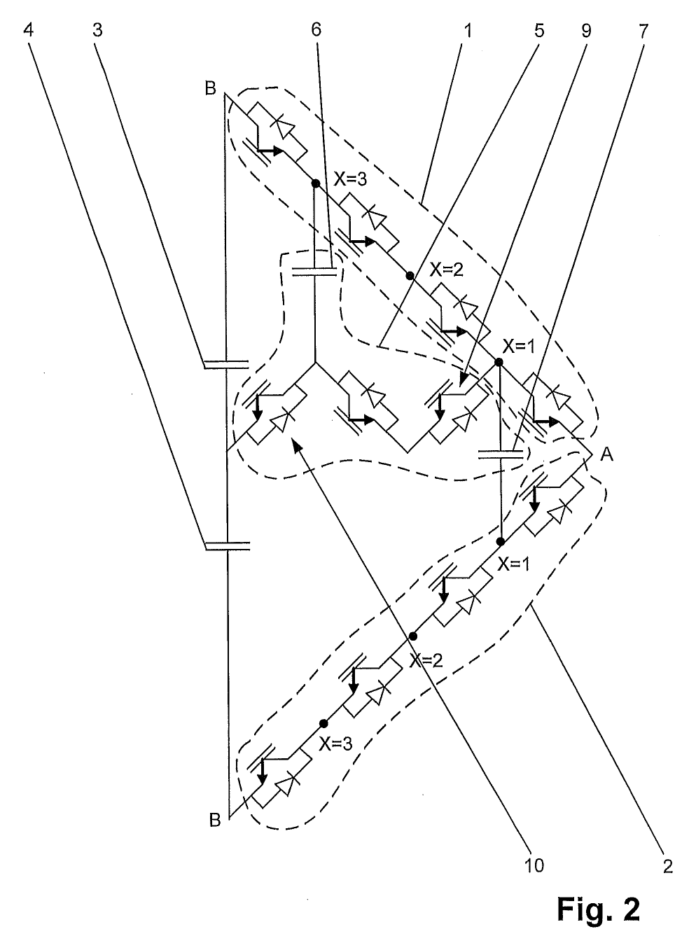

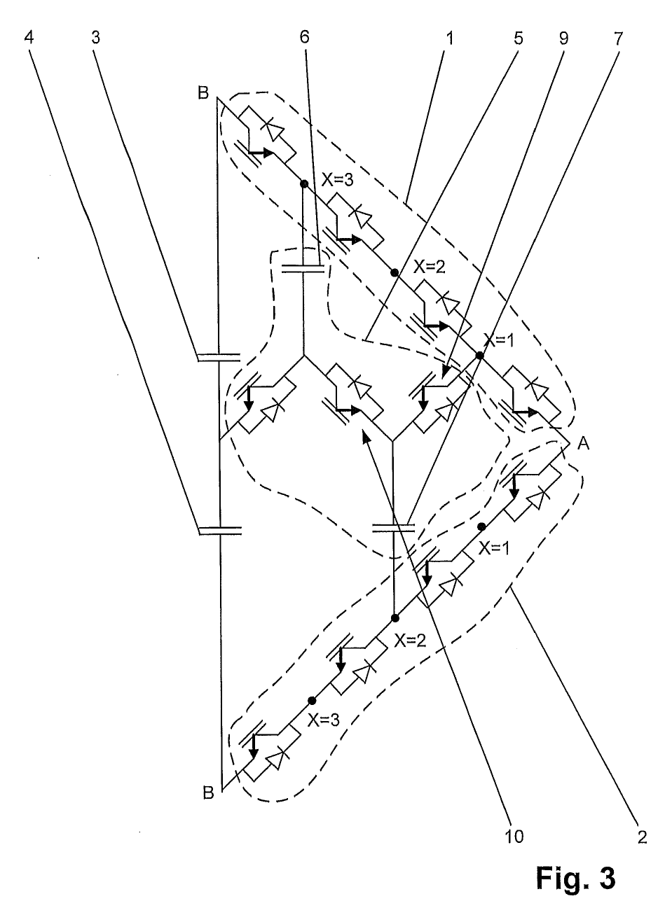

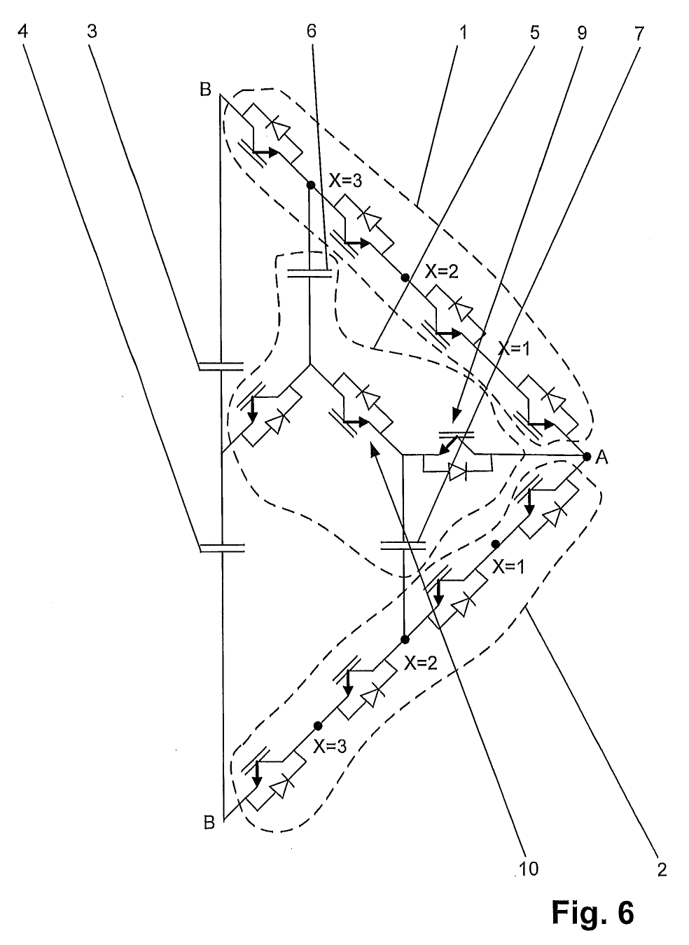

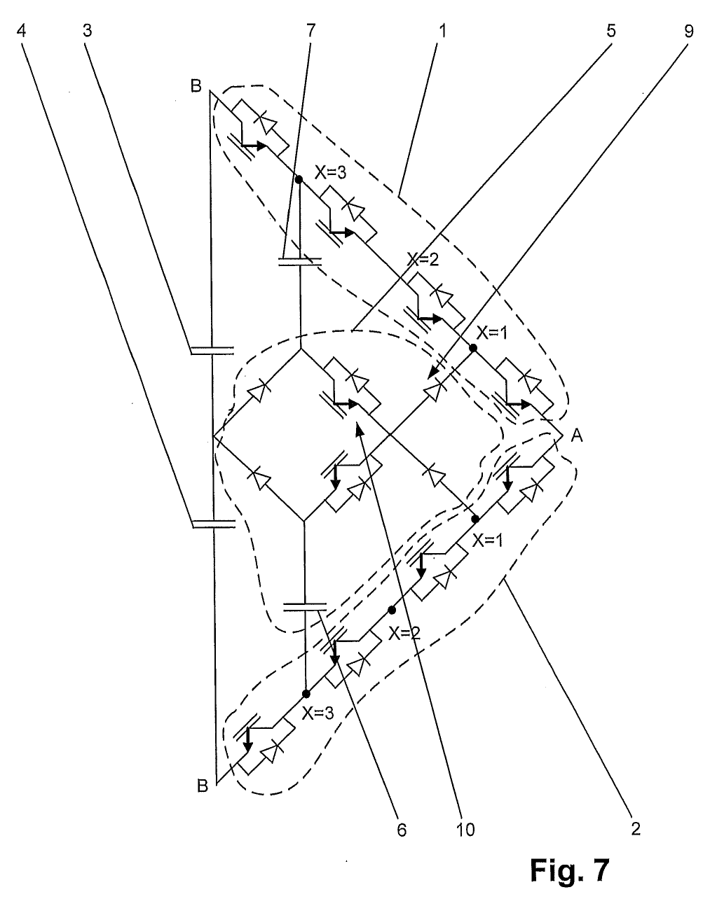

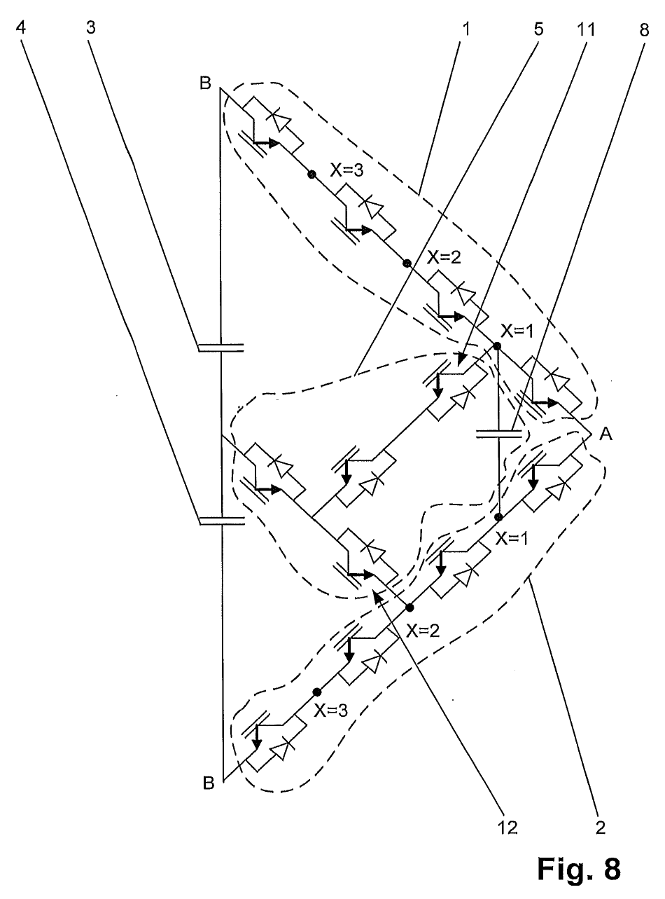

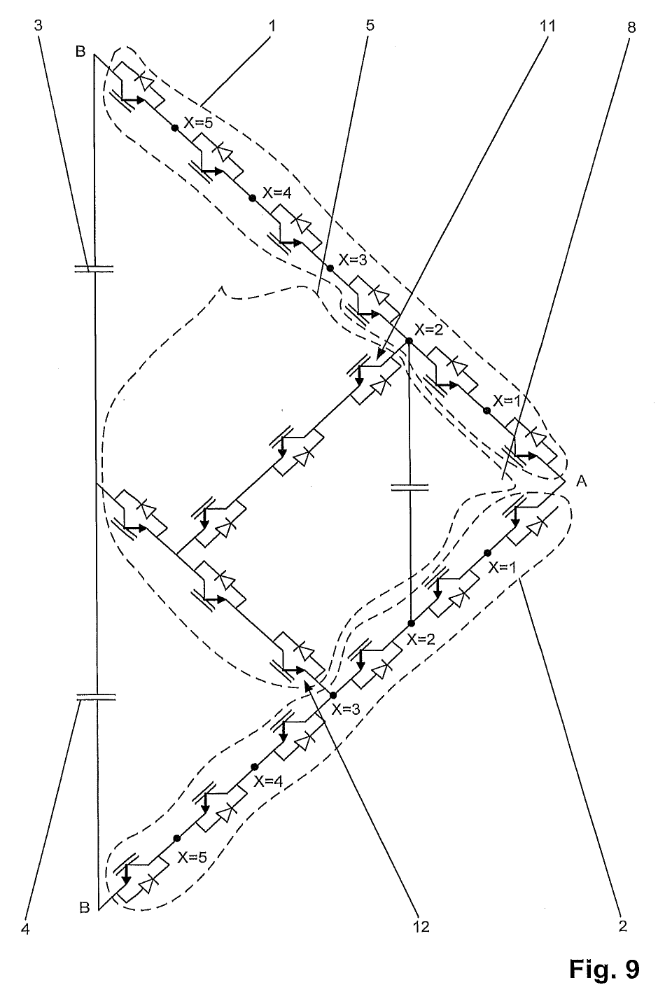

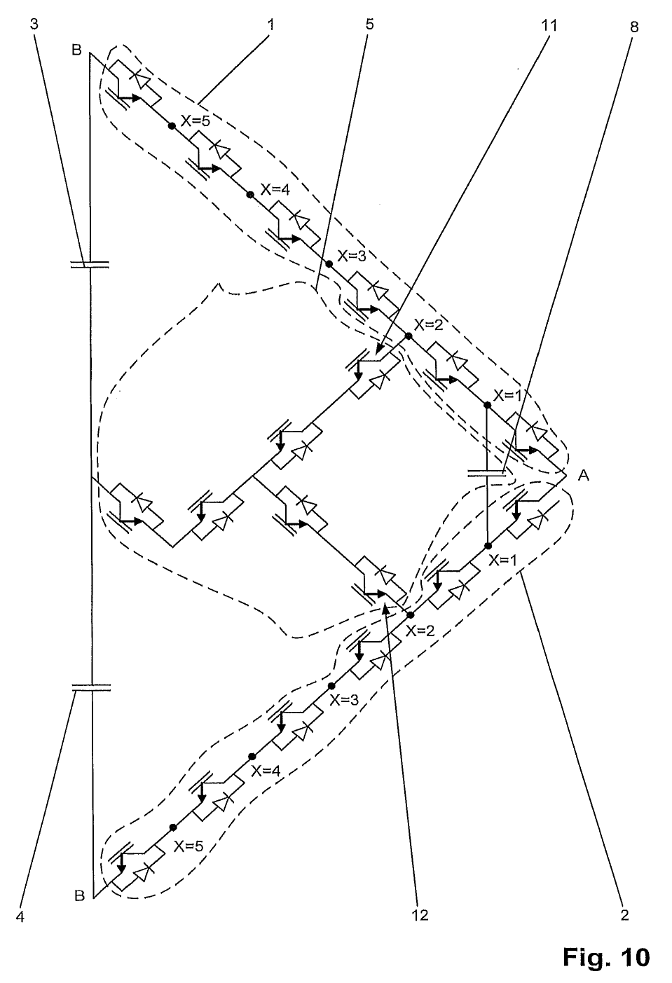

FIG. 1 shows a first exemplary embodiment of a switchgear cell according to the disclosure for switching n voltage levels, where n=5, 7, 9 . . . . FIG. 2 to FIG. 10 illustrate further exemplary embodiments of the switchgear cell according to the disclosure. In FIG. 1 to FIG. 5 and also FIG. 7 and FIG. 8, the respective switchgear cell is embodied, by way of example, for switching n=5 switching voltage levels. By contrast, in FIG. 6, FIG. 9 and FIG. 10, the respective switchgear cell is embodied by way of example for switching n=7 switching voltage levels.

Exemplary switchgear cells according to the disclosure can include a first and a second branch circuit 1, 2, wherein each branch circuit 1, 2 comprises n-1 series-connected controllable bidirectional power semiconductor switches having a controlled unidirectional current-carrying direction. It goes without saying that the number n switching voltage levels where n=5, 7, 9, . . . is understood to be the maximum possible number, such that switching voltage levels smaller than n, for example four switching voltage levels in the case of n=5 maximum possible switching voltage levels, can also be switched.

A respective controllable bidirectional power semiconductor switch having a controlled unidirectional current-carrying direction is formed in FIG. 1 to FIG. 10 by way of example by a bipolar transistor having a insulated gate electrode (IGBT) and by a diode reverse-connected in parallel with the bipolar transistor. It is also possible, however, to embody an abovementioned controllable bidirectional power semiconductor switch, for example, as a power MOSFET with a diode additionally reverse-connected in parallel. It is also possible to embody the respective controllable bidirectional power semiconductor switch having a controlled unidirectional current-carrying direction as an integrated thyristor having a commutated gate (IGCT) and a diode reverse-connected in parallel therewith, for example, in order to be able to switch an increased voltage. Such a thyristor has particularly low active power losses in conjunction with high robustness, primarily at high voltages and in particular at overvoltages.

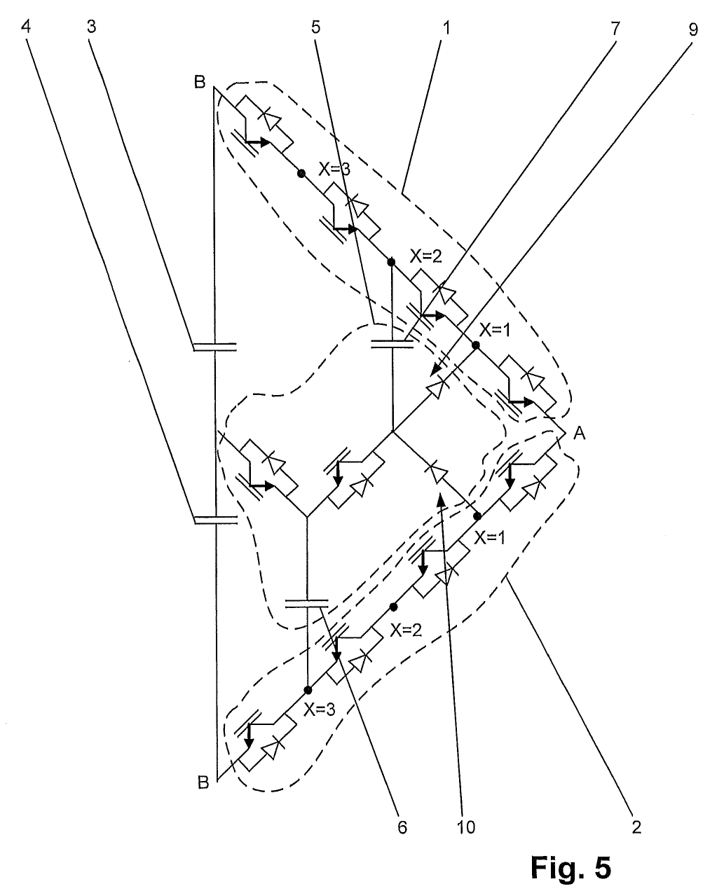

Furthermore, each switchgear cell can include first ends A of the branch circuits 1, 2, which are connected to one another, and second ends B of the branch circuits 1, 2, which are connected to one another via a series circuit of a first and a second energy store 3, 4. If the switchgear cell is used in a converter circuit, for example, the connection of the two first ends A of the branch circuits 1 and 2 can form an AC voltage phase connection. Furthermore, p=n-2 power semiconductor switch junction points between the series-connected controllable bidirectional power semiconductor switches having a controlled unidirectional current-carrying direction of each branch circuit 1, 2 can be provided, wherein for each branch circuit the power semiconductor switch junction points can be counted starting with an odd counting number x from the first end A to the second end B of the respective branch circuit 1, 2. In FIG. 1 to FIG. 10, the odd counting number x starts at the first end A of the respective branch circuit 1, 2 by way of example with x=1 and is then counted integrally to the second end B of the respective branch circuit 1, 2. Furthermore, an intermediate circuit 5 can be provided, which is connected to the junction point between the first and the second energy store 3, 4 and which can include a multiplicity of power semiconductor switches. According to the disclosure, in particular in accordance with FIG. 1 to FIG. 3, and also in accordance with FIG. 5 to FIG. 7, the intermediate circuit 5 can include a first and a second capacitance 6, 7, wherein the first capacitance 6 is connected to a power semiconductor switch junction point having an odd counting number x of the first branch circuit 1 and the second capacitance 7 is connected to a power semiconductor switch junction point of the second branch circuit 2. In addition, a power semiconductor switch 9 of the intermediate circuit 5 can be directly connected to a power semiconductor switch junction point having a counting number x<(p+1)/2 of the first or second branch circuit 1, 2 or to the first end A. The connection to the first end A can, for example, improve current and voltage distribution via the switches, and improve distribution of the switch loading.

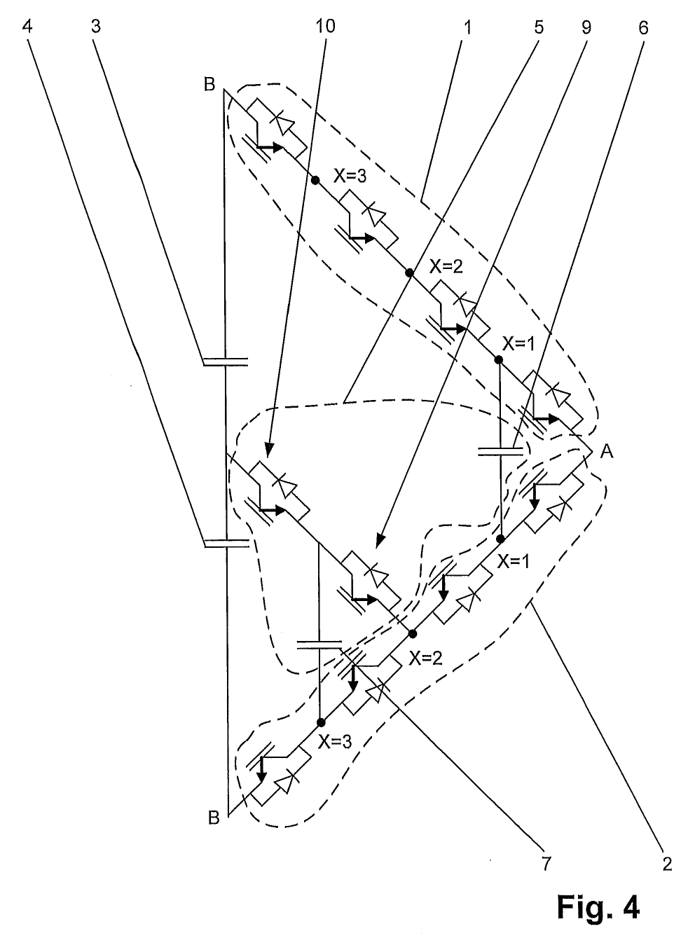

As an alternative thereto, for example, in accordance with FIG. 4, the power semiconductor switch 9 of the intermediate circuit 5 according to the disclosure can be connected only to a power semiconductor switch junction point having a counting number x=(p+1)/2 of the first branch circuit I or only to a power semiconductor switch junction point having a counting number x=(p+1)/2 of the second branch circuit 2.

As a further alternative, in accordance with FIG. 8 to FIG. 10, an exemplary intermediate circuit 5, according to the disclosure can include a capacitance 8, wherein the capacitance 8 is connected to a power semiconductor switch junction point having a counting number x<(p+1)/2 of the first and second branch circuits 1, 2. Furthermore, a power semiconductor switch 11 of the intermediate circuit 5 can be connected to a power semiconductor switch junction point having a counting number x<(p+1)/2 of the first or second branch circuit 1, 2, and a further power semiconductor switch 12 of the intermediate circuit 5 can be directly connected to a power semiconductor switch junction point having a counting number x≦(p+1)/2 of the first or second branch circuit 1, 2, wherein the further power semiconductor switch 12 of the intermediate circuit 5 is then not directly connected to the capacitance 8 of the intermediate circuit 5.

The multiplicity of the power semiconductor switches of the intermediate circuit 5 can likewise be embodied as controllable bidirectional power semiconductor switches having a controlled unidirectional current-carrying direction, as shown by way of example in FIG. 1 to FIG. 10, or can alternatively be embodied in part as non-controllable unidirectional power semiconductor switches, as illustrated for example in FIG. 5.

Overall it is thus possible to realize a switchgear cell for switching n or less switching voltage levels, where n=5, 7, 9 . . . , having particularly few components and connections in respect thereof and thus a particularly simple switchgear cell overall, and which in addition can have a small space requirement. As a result of the low circuitry outlay, the switchgear cell according to the disclosure can be very robust, not very susceptible to interference and can be thus distinguished by a high availability. On account of the low circuitry outlay, the control outlay with regard to the switching elements can in addition likewise be kept low. A further exemplary advantage of the switchgear cell according to the disclosure is that it is possible to set or regulate the current at the junction point between the first and the second energy store 3, 4 by means of the intermediate circuit 5 in a bidirectional direction. The abovementioned alternative switchgear cell according to the disclosure can additionally manage with just one capacitance 8 and can be extremely simple and cost-effective to realize.

In accordance with FIG. 1, the power semiconductor switch 9 of the intermediate circuit 5 that is connected to a power semiconductor switch junction point having a counting number x<(p+1)/2 of the first or second branch circuit 1, 2 is connected to the first capacitance 6. Furthermore, the power semiconductor switch 9 of the intermediate circuit 5 is connected to the first capacitance 6 at the junction point between the first capacitance 6 and the power semiconductor switch junction point having a counting number x<(p+1)/2 of the first or second branch circuit 1, 2.

In the embodiments according to FIG. 1 to FIG. 7, a further power semiconductor switch 10 of the intermediate circuit 5 is connected to the second capacitance 7.

Furthermore, in accordance with FIG. 5, a further power semiconductor switch 10 of the intermediate circuit 5 is connected to a power semiconductor switch junction point having a counting number x≦(p+1)/2 of the first or second branch circuit 1, 2.

In accordance with an exemplary alternative of the switchgear cell disclosed herein, and in accordance with FIG. 8 and FIG. 9, the power semiconductor switch 11 of the intermediate circuit 5 that is connected to a power semiconductor switch junction point having a counting number x≦(p+1)/2 of the first or second branch circuit 1, 2 is connected to the capacitance 8. The power semiconductor switch 11 of the intermediate circuit 5 is connected to the capacitance 8 at the junction point between the capacitance 8 and the power semiconductor switch junction point having a counting number x<(p+1)/2 of the first or second branch circuit 1, 2.

It goes without saying that the person skilled in the art could combine features from among any or all of the embodiments of the switchgear cell 1 as discussed in the disclosure and/or as illustrated according to FIG. 1 to FIG. 10 with regard to the intermediate circuit 5 and also parts of the intermediate circuit 5.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

1 First branch circuit
2 Second branch circuit
3 First energy store
4 Second energy store
5 Intermediate circuit
6 First capacitance of the intermediate circuit
7 Second capacitance of the intermediate circuit
8 Capacitance of the intermediate circuit
9 Power semiconductor switch of the intermediate circuit
10 Further power semiconductor switch of the intermediate circuit
11 Power semiconductor switch of the intermediate circuit
12 Further power semiconductor switch of the intermediate circuit
A First ends of the branch circuits
B Second ends of the branch circuits

What is claimed is:

1. A switchgear cell for switching n or less switching voltage levels, where n is an odd number of 5 or greater, the switchgear cell comprising:
a first and a second branch circuit, wherein each branch circuit includes n-1 series-connected controllable bidirectional power semiconductor switches which are reverse conducting, first ends of the branch circuits being connected to one another, and second ends of the branch circuits being connected to one another via a series circuit of a first and a second energy store;
p=n-2 power semiconductor switch junction points among the series-connected controllable bidirectional power semiconductor switches having a controlled unidirectional current-carrying direction within each branch circuit; and
an intermediate circuit connected to a junction point between the first and the second energy store, the intermediate circuit including:
multiple power semiconductor switches; and
a first and a second capacitance wherein the first capacitance is connected to a power semiconductor switch junction point having an odd counting number x of the first branch circuit when the power semiconductor switch junction points of each branch circuit are numbered starting with an odd counting number x from the first end to the second end of each respective branch circuit, and wherein the second capacitance is connected to a power semiconductor switch junction point of the second branch circuit, a power semiconductor switch of the intermediate circuit being directly connected to a power semiconductor switch junction point having a counting number x<(p+1)/2 of the first or second branch circuit or being directly connected to the first end of the first or the second branch circuit.

2. A switchgear cell for switching n or less switching voltage levels, where n is an odd number of 5 or greater, the switchgear cell comprising: a first and a second branch circuit, wherein each branch circuit includes n-1 series-connected controllable bidirectional power semiconductor switches having a controlled unidirectional current-carrying direction, first ends of the branch circuits being connected to one another, and second ends of the branch circuits being connected to one another via a series circuit of a first and a second energy store;
p=n-2 power semiconductor switch junction points among the series-connected controllable bidirectional power semiconductor switches having a controlled unidirectional current-carrying direction within each branch; and
an intermediate circuit connected to a junction point between the first and the second energy store, the intermediate circuit including:
multiple power semiconductor switches; and
a capacitance, wherein the capacitance is connected to a power semiconductor switch junction point having a counting number x<(p+1)/2 of the first and second branch circuits when the power semiconductor switch junction points are counted starting with an odd counting number x from the first end to the second end of each respective branch circuit, a power semiconductor switch of the intermediate circuit being connected to a power semiconductor switch junction point having a counting number x<(p+1)/2 of the first or second branch circuit, and wherein another of the power semiconductor switches of the intermediate circuit is directly connected to a power semiconductor switch junction point having a counting number x≦(p+1)/2 of the first or second branch circuit, and the another power semiconductor switch of the intermediate circuit is not directly connected to the capacitance of the intermediate circuit.

3. A switchgear cell for switching n or less switching voltage levels, where n is an odd number of 5 or greater, the switchgear cell comprising:
a first and a second branch circuit, wherein each branch circuit includes n-1 series-connected controllable bidirectional power semiconductor switches having a controlled unidirectional current-carrying direction, first ends of the branch circuits being connected to one another, and second ends of the branch circuits being connected to one another via a series circuit of a first and a second energy store;
p=n-2 power semiconductor switch junction points among the series-connected controllable bidirectional power semiconductor switches having a controlled unidirectional current-carrying direction within each branch circuit; and
an intermediate circuit connected to a junction point between the first and the second energy store, the intermediate circuit including:
multiple power semiconductor switches; and
a first and a second capacitance, wherein the first capacitance is connected to a power semiconductor switch junction point having an odd counting number x of the first branch circuit when the power semiconductor switch junction points are counted starting with an odd counting number x from the first end to the second end of each respective branch circuit, and the second capacitance is connected to a power semiconductor switch junction point of the second branch circuit, a power semiconductor switch of the intermediate circuit being connected only to a power semiconductor switch junction point having a counting number x=(p+1)/2 of the first branch circuit or only to a power semiconductor switch junction point having a counting number x=(p+1)/2 of the second branch circuit.

4. The switchgear cell as claimed in claim 1, wherein the power semiconductor switch of the intermediate circuit that is connected to a power semiconductor switch junction point having a counting number x<(p+1)/2 of the first or second branch circuit is connected to the first capacitance.

5. The switchgear cell as claimed in claim 4, wherein the power semiconductor switch of the intermediate circuit that is connected to the first capacitance is connected at the junction point between the first capacitance and the power semiconductor switch junction point having a counting number x<(p+1)/2 of the first or second branch circuit.

6. The switchgear cell as claimed in claim 1, wherein another power semiconductor switch of the intermediate circuit is connected to the second capacitance.

7. The switchgear cell as claimed in claim 1, wherein another of the power semiconductor switches of the intermediate circuit is connected to a power semiconductor switch junction point having a counting number x≦(p+1)/2 of the first or second branch circuit.

8. The switchgear cell as claimed in claim 2, wherein the power semiconductor switch of the intermediate circuit that is connected to a power semiconductor switch junction point having a counting number x≦(p+1)/2 of the first or second branch circuit is connected to the capacitance.

9. The switchgear cell as claimed in claim 8, wherein the power semiconductor switch of the intermediate circuit that is connected to the capacitance is connected at the junction point between the capacitance and the power semiconductor switch junction point having a counting number x<(p+1)/2 of the first or second branch circuit.

10. The switchgear cell as claimed in claim 5, wherein another of the power semiconductor switches of the intermediate circuit is connected to the second capacitance.
